(19) United States
(12) Patent Application Publication
(10) Pub. No.: US 2014/0248967 A1
(43) Pub. Date: Sep. 4, 2014

(54) SPLINED GEARING

(71) Applicant: Harrier Technologies, Inc,, Greenwich, CT (US)

(72) Inventors: Edward Hahlbeck, Pewaukee, WI (US); William Bruce Morriw, Santa Barbara, CA (US); David Kenneth Neidig, Plymouth, IN (US); Lee Miller, Greenwich, CT (US)

(73) Assignee: Harrier Technology, Inc., Greenwich, CT (US)

(21) Appl. No.: 13/783,753

(22) Filed: Mar. 4, 2013

(51) Int. Cl. F16D 3/06

(52) U.S. Cl. CPC F16D 3/065
USPC 464/167

(57) ABSTRACT

In a splined drive wherein the teeth of a male spline and the teeth of a female spline are interposed in driving relation, a plurality of friction inhibitors in a string interposed between at least some of said male splined teeth and said female splined teeth and stops disposed at either end of said string of friction inhibitors to limit longitudinal travel of the string, with springs, or other elastic devices, interposed between the string of friction inhibitors and stops to center the friction inhibitors between the stops.

The present invention relates, in a general sense, to splined gearing and, more particularly, to devices for minimizing friction between splined teeth so as to reduce, if not minimize, frictional forces which impair the efficiency of splined gearing.

### BACKGROUND OF THE INVENTION

1. Field of the Invention

Broadly, splined connections are an effective way to connect two shafts so that torsional force can be transmitted between the two, but allow some freedom of relative axial movement between the two shafts. The torsional forces transmitted via the splines, however, result in significant friction in the spline, which inhibits the freedom of axial movement, sometime to such an extent that the spline “locks up” so that no relative axial movement can occur.

An example of a structure which can and will benefit from the present invention is graphically illustrated in Sullivan, et al., U.S. Pat. No. 7,963,190. In that transmission, splined shafts which torsionally connect adjacent gears to one another are required to allow some small axial movement resulting from lateral forces due to the natural axial thrust of loaded helical gears. Conventional splines are characterized by metal to metal contact between the surfaces of the male and female splines. Torsional loading of these splines during the transmittal of torque between the gears can result in large contact forces between the mating teeth of the male and female splines. In some cases, the friction due to the large contact forces between the spline teeth is greater than the axial forces due to the helical gearing, and the required axial movement between the spline components cannot occur, and the spline “locks up.”

The present invention suggests a simple, yet effective, and heretofore unheard of solution to the articulated problem, namely, the imposition of friction inhibitors, in the form of rolling elements such as ball bearings or roller bearings, between the mating splined teeth in very high load, limited axial displacement applications.

2. Overview of the Related Art

There are, of course, an untold number of applications employing ball bearings and/or roller bearings situated in bearing races used to minimize the friction between two rotating elements, or between a rotating element about a stationary shaft.

FIG. 2 of the drawings is illustrative of the current application where ball bearings are situated in the grooves between spline teeth to allow transmission of torque from a rotating shaft, wherein the ball bearings are circulated in a continuous loop. This application, termed a ball spline, is designed to provide rotating force over a long axial distance. Other than that, no other application has been found.

### SUMMARY OF THE INVENTION

A principal objective of the present invention is to reduce friction and thereby increase the efficiency of a splined connection by interjecting a series of ball bearings and/or roller bearings between mating teeth of a spline drive. Another objective is to reduce wear between the teeth of splines on mating drive and driven shafts.

An additional objective related to the foregoing, is to facilitate axial movement between mating splines being subjected to large torsional forces.

The foregoing, as well as other objects and advantages of the present invention, will become apparent to those skilled in the art from a reading of the Detailed Description of a Preferred Embodiment taken in conjunction with the drawings, wherein:

### BRIEF DESCRIPTION OF THE DRAWINGS

FIG. 1 is a side elevation, partially sectioned, showing a conventional splined connection, with a drive and driven shaft having male splined ends drivingly joined by an internally splined female coupler;

FIG. 2 is a perspective view of a “roller spline” assembly, showing the continuous, recirculating ball mechanism;

FIG. 3 is an end view of one of the shafts, within a coupler, illustrating ball bearings positioned between each of the teeth;

FIG. 4A is an amplified partial section of FIG. 3 providing an amplified view of the inter relationship between the male and female splines with ball bearings interposed. The contour of the spline teeth are modified compared to those in FIG. 3, to provide a more vertical bearing surface;

FIG. 4B illustrates a spline tooth configuration wherein the mating teeth extend radially nearly the entire diameter of the ball, with the bearing faces of the adjacent male and female spline teeth being parallel to one another.

FIG. 5 is a pictorial illustration of sample ball bearings interposed between adjacent male and their engaged female tooth of a spline assembly in which the splines are initially at rest;

FIG. 6 illustrates, pictorially, the movement of the ball bearings of FIG. 5 between male spline teeth moving to the right, as shown, relative to female spline teeth moving relatively to the left, as shown, with ball retainers positioned to limit movement of the ball bearings;

FIG. 7 is a view similar to FIG. 5, except that the ball bearings are stacked against the left retainer with a male spline being at rest;

FIG. 8 illustrates the movement of the ball bearings when the female spline teeth move to the left, relative to the male spline teeth. Under such circumstances, and by virtue of this stacked position of ball bearings, they will skid along the female spline teeth tooth surface;

FIG. 9 is, once again, a view similar to FIGS. 5 and 7, with the exception that bumpers, in the nature of springs, are provided and are shown with the splined teeth being at rest;

FIG. 10 is a view similar to that of FIG. 9 and illustrates the relative compression of the bumper springs as the splined teeth experienced movements such as that found in FIG. 6;

FIG. 11 is a view similar in content to FIG. 9, the principle distinction being that the ball bearings of FIG. 9 are replaced by roller bearings. The female spline tooth is removed for clarity;

FIG. 12 is a view such as that of FIG. 10, except that, once again, ball bearings have been replaced by roller bearings;

FIG. 13 is a pair of the proposed shafts having male splined ends in a coupler sectioned to show the inter relationship of the splines, rollers and bumper springs;

FIG. 14 is an illustration of a splined shaft engaged with a female splined shaft sectioned to illustrate the interrelationship of the rollers between the male and female splines;

### DETAILED DESCRIPTION OF PREFERRED EMBODIMENTS

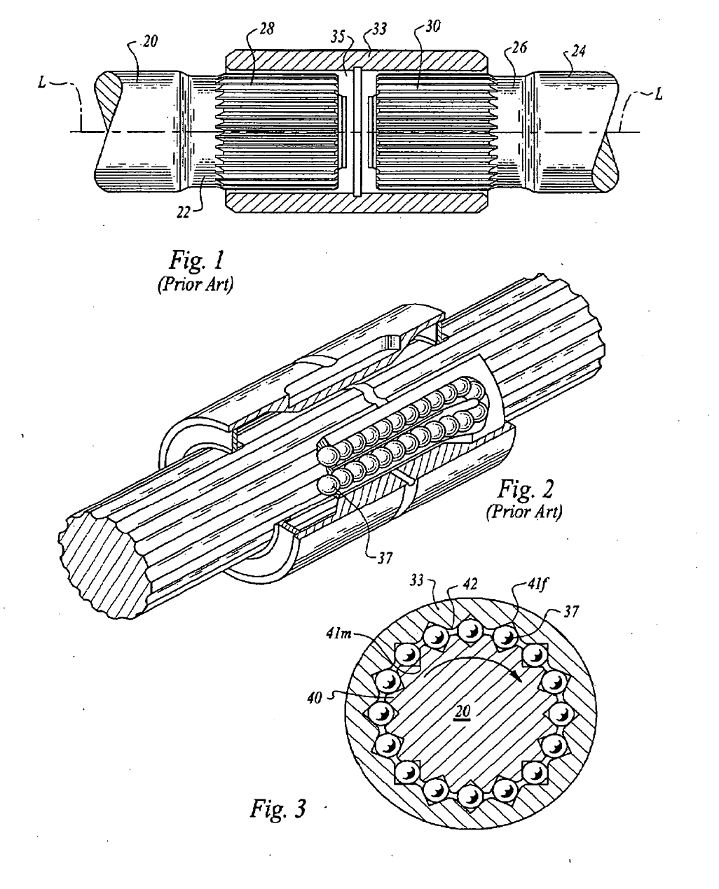

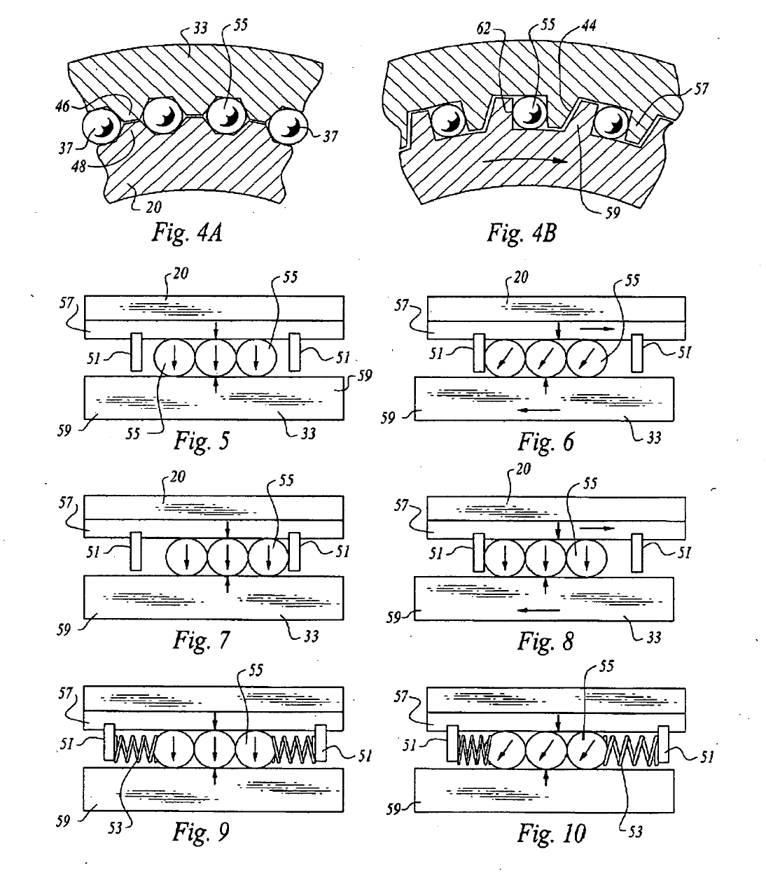

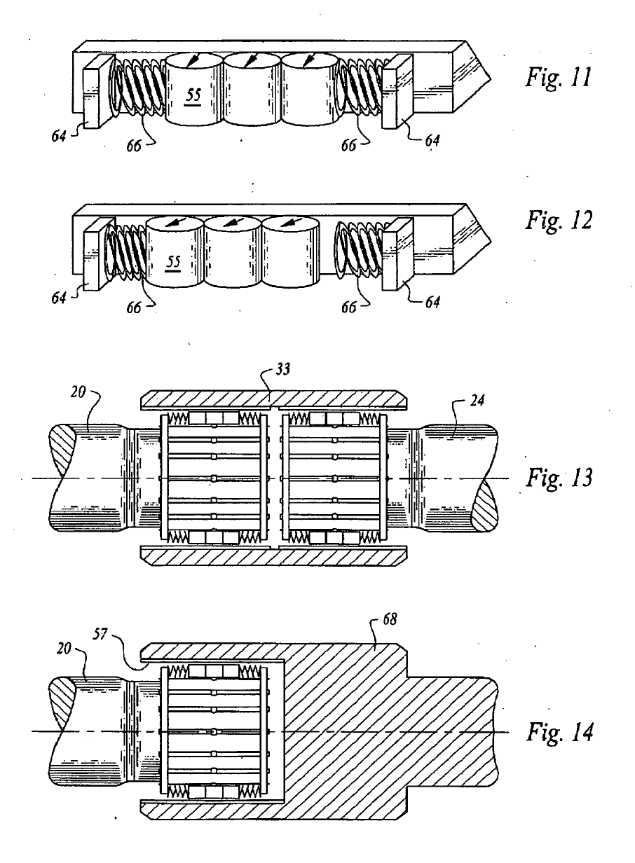

With reference now to the drawings, and, initially to FIG. 1, an environment in which the present invention has particular utility is illustrated. An input shaft 20 having an end 22 is oriented horizontally in axial alignment to an output shaft 24 having an end 26. The ends 22 and 26 are formed with male splines 28 and 30, respectively. A coupler 33 having internally formed female splines 35 encircles the splined ends 22 and 26 of the drive and driven shafts 20 and 24, thereby creating a positive engagement between the shafts 20 and 24. It will be appreciated that the splined ends 22 and 26 may be meshed correctly to create a driving relationship. The purpose of this splined connection is to provide a driving connection of the two shafts in torsion, but without allowing the shafts to move longitudinally relative to one another.

For purposes of clarity, let it be understood that a spline is a longitudinally disposed key, or tooth, and when reference is made to the splined ends 22 and 26, for example, it means that a series of spaced splines are disposed about the end. The male splines of the shaft 20, for example, engage the female splines of, in the illustrated case, coupler 33 creating a positive drive arrangement. When the coupler 33 engages shafts 20 and 24, which are in alignment along the longitudinal axis L-L, forces applied to the shaft 20 are transmitted positively to the shaft 24.

When the drive shaft is rotated, torsional force is exerted on the driven shaft by the driving shaft, via the connecting female spline coupling, the torsional force causes the mating teeth of the male and female splines to forcibly bear on one another. In a conventional spline drive, similar to that shown in FIG. 1, the contact between the male and female teeth is metal-on-metal surface contact. The surface contact results in surface friction inhibiting relative longitudinal movement of the spline connection elements. As transmitted torsional force increases, so does the surface contact pressure and, hence, the surface friction between the mating teeth.

In use currently is an arrangement shown in FIG. 2. Illustrated there is a driving male spline shaft and a female spline assembly which uses an unbroken loop, or chain, of friction inhibitors in the nature of ball bearings 37, in a continuous, recirculating string between and about adjacent teeth of the male and female splines. The continuous recirculating ball bearing arrangement is needed to allow significant axial movement of the female spline assembly along the male spline shaft. It will be seen in FIG. 2 that only a fraction of the surface of the drive shaft has machined spline grooves. This is required to provide space for the ball recirculation circuit to the sides of the active spline grooves, resulting in no more than half of the shaft surface having active, load bearing spline grooves.

To get adequate torsional capacity, therefore, a significant length of the few active spline grooves is engaged by a large number of balls. The combination of a required return ball circuit mechanism, and the large number of balls per spline groove results in the female spline assembly being quite large in diameter and length for the torsional strength provided.

The recirculating ball spline described above is designed to allow the female spline assembly to move significant distances back and forth along the driving male spline shaft.

There are many important applications where two shafts require a spline connection, but only require a small amount of relative axial, or longitudinal, movement between the shafts, e.g., significantly less than the diameter of the drive and driven shafts. And many spline applications have both diameter and length constraints that would make the adaptation of a recirculating ball spline system infeasible. It is, for these applications, that the current invention is proposed.

Moving briefly to FIG. 3, a graphic representation of the fundamentals of the present invention is illustrated in a cross-section of a spline drive employing friction inhibitors in a line or string in a plane transverse to the longitudinal axis of a spline drive. Specifically, a drive shaft having a splined end 20 is shown with a series of male teeth 40 on the drive shaft and female spline teeth 42 on the coupler 33, with friction inhibitors in the nature of ball bearings 44 interposed there between. Each tooth is separated by a valley, in the case of the male spline, valley 41M and with the female spline, valley 41F.

Moving now to FIGS. 4 through 10, the present invention offers a straightforward solution to an otherwise complex problem.

Initially addressing FIG. 4A, an enlarged partial sectional view of FIG. 3 is shown. FIG. 4A depicts a modified tooth configuration for a spline assembly in which a input shaft 20, for example, is mated with a coupler 33, with ball bearings 37 interposed between mating teeth. It will be noted that the tooth 46 on the coupler 33 and the tooth 48 on the input shaft 20 are trapezoidal in shape, rather than triangular, to provide the bearing surfaces of the teeth a m ore upright angle of contact with the balls, which increases the tangential component of the contact forces between the balls and the teeth, as well as providing for a stronger tooth. Note, however, in both the FIG. 3 and FIG. 4A configurations, the spline teeth of both the driving shaft and the coupler extend vertically only to half of the diameter of the ball, so the bearing points are off center on the balls, resulting in a radial, as well as tangential, component of the inter-tooth forces due to interaction with the balls.

Addressing FIG. 4B, note that in this configuration the spline teeth extend nearly the full diameter of the balls and contact the balls with vertical surfaces so that there is no radial component of the forces between the teeth and the balls. This tooth configuration is the preferred one for the present invention, although the configurations shown in FIGS. 3 and 4A would also function satisfactorily.

Moving to FIG. 5 next, a pictorial representation of the action of the ball bearings is provided. FIG. 5 shows a tangential section through the contact points between the balls 55 and the teeth, female tooth 57 and male tooth 59, along the axis of the spline shaft. In order to provide adequate control over the ball bearings between adjacent teeth, there is provided, in keeping with the invention, stops 51 at the remote end of a string of longitudinally aligned ball bearings 55. It will be appreciated that the stop can be one of any number of devices capable of offering resistance to a short line of ball bearings as the male and female splines move a small distance relative to one another upon rotation and loading thereof.

In the FIG. 5 configuration, the driving shaft 20 and the female coupling 33 have no relative axial movement, and the balls between the male spline teeth 58 and female coupling teeth 57 are centered between the stops 51.

FIG. 6 shows the location and orientation of the balls after some axial displacement between the male and female splines. The balls have rolled about one tenth of a rotation (−36°) and are up against the stop 51. Any further relative axial movement between the male and female splines will cause the balls to skid along the spline teeth surfaces, rather than roll. The condition of the balls skidding rather than rolling dramatically increases the friction between the two spline surfaces.

In actual application of such a spline configuration, one cannot be sure that prior to relative axial movement of the male and female spline surfaces that the balls will be perfectly centered between the two stops 51, as shown in FIG. 5. In practice, the situation shown in FIG. 7 is probably more likely, with all the balls clustered up against one of the two stops. If relative axial movement between the splines as shown in FIG. 8 is then required, the balls are not free to roll and, instead slide, or skid, along the male and female tooth surfaces, inhibiting the relative axial movement due to the skidding friction of the balls against the tooth surfaces.

To solve this problem of off center initial location of the ball string, centered springs 53 are provided between the balls and the sops 51, as shown in FIG. 9. The action of these springs 53 causes the ball bearings to stay in contact with one another, as well as centered between the stops when the spline is unloaded. When the male and female splines are moved relative to one another as shown in FIG. 6, the ball bearing chain will move slightly, as previously discussed, and will compress the left hand spring and provide certain relief for the right hand spring. If the spline is again unloaded, the springs will cause the ball string to re-center itself between the stops in preparation for the next bout of relative axial movement.

FIGS. 11 and 12 are a perspective view of the interaction between the spline teeth and the rolling elements between them, similar to the configuration shown in FIGS. 9 and 10. The female tooth 57 is not shown for clarity. Note that the friction inhibitor is a string of roller bearings, as distinguished from a ball bearing. It will be seen in those figures that the roller bearings behave in a spline drive environment, essentially the same as ball bearings, the difference being that roller bearings, by virtue of their linear, rather than point, contact with spline teeth, are capable of transmitting, and otherwise handling, more substantial loading that can ball bearings.

Digressing for the moment to FIG. 4B, the use of roller bearings instead of ball bearings with the tooth configuration shown in the figure greatly increases the load carrying capacity of the spline by taking maximum advantage of the linear contact between the spline tooth surface and the roller bearing 55.

FIGS. 13 and 14 are offered to demonstrate the various spline drive arrangements which are experienced in industrial environments. FIG. 13 shows a basic drive and driven shafts, which are coaxial, with their respective ends having male splines formed thereon, and with a coupler having internal females splines adjoining adjacent splined ends.

FIG. 14 is illustrative of the drive shaft having a splined end connecting directly into the end of a driven shaft, in which the driven shaft is recessed and is formed with female splines on the interior wall thereof.

While those skilled in the art will find several deviations from the description hardware acceptable in the present environment, it will be appreciated that such deviations are within the contemplation of the invention as described by the claims, where in:

1. In a splined drive in which a male splined drive is intermeshed with a female splined drive in driving relation; said male splined drive and said female splined drive each having a series of adjacent longitudinally extending teeth;
a string of friction inhibitors interposed between at least some of said male splined teeth and a adjacent female splined tooth;
a stop positioned at each end of said string of friction inhibitors, said stop adapted to limit longitudinal travel of said string of friction inhibitors;
a resilient member, said resilient member, interposed between the string of said friction inhibitors and the said stops, said device adapted to center the string of friction inhibitors between the said stops.

2. (canceled)

3. The system of claim 1, wherein the friction inhibitors comprise roller bearings.

4. The system of claim 1, wherein resilient members are attached to said stop.

5. The system of claim 4, wherein said resilient members constitute springs.

6. The system of claim 1, wherein each tooth of said splined drive system has a straight side and the straight side of the male splined driver teeth engages the straight side of the female splined driver teeth.

7. The system of claim 1, wherein each tooth of said splined drive system has a trapezoidal side and the trapezoidal side of the male splined driver teeth engages the trapezoidal side of the female splined driver teeth.

8. In a splined drive system having a drive shaft with splines formed at one end thereof, a driven shaft, said driven shaft having a splined drive end thereof, said drive shaft and driven shaft being in axial alignment;
a coupler, said coupler having splined teeth formed on the interior thereof, said splined teeth of said coupler engaging the splined teeth of said drive shaft and the splined teeth of said driven shaft to form a splined driver system.

9. The system of claim 3, wherein said resilient members constitute springs.

10. The system of claim 3, wherein each tooth of said splined drive system has a straight side and the straight side of the male splined driver teeth engages the straight side of the female splined driver teeth:

11. The system of claim 3, wherein each tooth of said splined drive system has a trapezoidal side and the trapezoidal side of the male splined driver teeth engages the trapezoidal side of the female splined driver teeth.

12. The system of claim 3, wherein said resilient members constitute springs.

13. The system of claim 3, wherein each tooth of said splined drive system has a straight side and the straight side of the male splined driver teeth engages the straight side of the female splined driver teeth.

14. The system of claim 3, wherein each tooth of said splined drive system has a trapezoidal side and the trapezoidal side of the male splined driver teeth engages the trapezoidal side of the female splined driver teeth.
